(19) United States
(12) Patent Application Publication
(10) Pub. No.: US 2003/0145316 A1
(43) Pub. Date: Jul. 31, 2003

(54) System, method and computer program product for initiating a software download

(76) Inventors: Eric McKinlay, Cupertino, CA (US); Christopher William Wesley, Redwood City, CA (US); David Lawrence Chambers, Etkins, NH (US); Craig Zeldin, San Francisco, CA (US); Mitchell T. Weisman, San Carlos, CA (US)

Correspondence Address: SQUIRE, SANDERS & DEMPSEY L.L.P, 600 HANSEN WAY, PALO ALTO, CA, 94304-1043, US

(21) Appl. No.: 10/056,956

(22) Filed: Jan. 25, 2002

(51) Int. Cl. G06F 9/44; G06F 9/445

(52) U.S. Cl. 717/173; 717/178

(57) ABSTRACT

A system, method, and computer program product are disclosed for initiating a software download. A page of a web site is accessed via a network utilizing a browser application running on a client computer. A plug-in application is included the page of the web site. Next, it is determined whether the client computer is suitable for receiving the plug-in application. If the client computer is determined to be suitable for receiving the plug-in application, then the plug-in application is downloaded from the web site to the client computer via the network. This plug-in application has instructions for downloading a download manager application to the client computer via the network. The download manager application is subsequently downloaded to the client computer via the network utilizing the plug-in application. The download manager application has instructions for downloading a software application in chunks to the client computer via the network. The software application is then downloaded in chunks to the client computer via the network utilizing the download manager application.

### CROSS REFERENCE TO RELATED APPLICATIONS

This application claims benefit of U.S. Provisional Application No. 60/______, filed Oct. 18, 2001 by United States Postal Service Express Mail Serial No. EL701362699US, entitled, “SYSTEM METHOD AND COMPUTER PROGRAM PRODUCT FOR COLLECTING INFORMATION ABOUT A NETWORK USER” (Attorney Reference No. 50642.00028) and which is incorporated by reference herein.

### FIELD OF THE INVENTION

This invention relates to computer software, and more particularly, relates to distribution of computer software utilizing a network.

### BACKGROUND

Computers perform specific tasks by following a set of instructions commonly known as “software”. A piece of software can be distributed to end-users by storing the software on removable storage media such as floppy diskettes or compact disks, and making the storage media available to the users. Typically, the storage medium includes the software to be installed and an installer. The installer is a specialized piece of software designed to assist users in the installation process. A user starts the installation process by inserting the storage medium in a storage medium reader (e.g., floppy drive, CD-ROM drive, etc.) of a computer, and then invoking the installer. In some operating systems, the installer is automatically invoked as soon as the storage medium is inserted in the reader. The installer asks the user a series of questions regarding her preferences as to file storage locations, the amount of files to install, default settings, etc. Thereafter, the installer proceeds to copy the software from the storage medium to the computer's mass storage device (e.g., hard disk drive), and performs any necessary configuration changes in accordance with the user's preferences.

Software can also be distributed by making the software available for download over a network. In that case, the software is stored on a server coupled to the network. A user who wishes to obtain the software couples her computer onto the network, and downloads the software from the server to her computer. The convenience of being able to obtain software at any time and the widespread availability of public networks such as the Internet contribute to the popularity of downloadable software.

Downloading software over a network is not without its share of problems. On the Internet, for example, a software vendor has to somehow alert potential users that a particular piece of software is available for download. Considering the cost of advertising and the number of competing software available on the Internet, an effective technique for informing potential users of the existence of the downloadable software, and convincing them to download the software, may be desirable.

The amount of time required to download software over a network affects the chances of having an error-free download and the users allowing the download to complete. If the download process takes a long time, such as when the software is large or the network connection is slow, there is a tendency for users to cancel the download prior to completion. Worse, transmission errors may occur in the middle of the download. Thus, a technique for increasing the likelihood of having a complete and successful download may also be desirable.

### SUMMARY

A system, method, and computer program product are disclosed for initiating a software download. A page of a web site is accessed via a network utilizing a browser application running on a client computer. A plug-in application is included the page of the web site. Next, it is determined whether the client computer is suitable for receiving the plug-in application. If the client computer is determined to be suitable for receiving the plug-in application, then the plug-in application is downloaded from the web site to the client computer via the network. This plug-in application has instructions for downloading a download manager application to the client computer via the network. The download manager application is subsequently downloaded to the client computer via the network utilizing the plug-in application. The download manager application has instructions for downloading a software application in chunks to the client computer via the network. The software application is then downloaded in chunks to the client computer via the network utilizing the download manager application.

In one embodiment of the present invention, the plug-in application may comprise an ActiveX control and/or a JavaScript application. In another embodiment, a security feature of the browser application of the client computer may require that a user authorize the downloading of the plug-in application. In such an embodiment, the security feature may include displaying a message to the user that notifies the user to authorize the downloading of the plug-in application. As another option, another page of the web site may be displayed to the user if the authorization to download the plug-in application is denied by the user. As a further option in such an embodiment, information about whether or not the downloading of the plug-in application was authorized by the user may be stored in the client computer.

In yet another embodiment of the present invention, determining the suitability of the client computer for receiving the plug-in application may include determining whether the number of times the client computer has accessed the web site is under a predetermined threshold number. In a further embodiment, another page of the web site may be displayed on the if the client computer is determined to be unsuitable for receiving the plug-in application. In an additional embodiment, a license agreement may be displayed on the client computer to the user prior to the downloading of the plug-in application. In even a further embodiment, the determination of the suitability of the client computer for receiving the plug-in application may be carried out by another web site. In another embodiment, the page of the web site launches a window which initiates the determination of the suitability of the client computer for receiving the plug-in application.

### BRIEF DESCRIPTION OF THE DRAWINGS

FIG. 1 shows a schematic block diagram of a computer network in accordance with an embodiment of the present invention;

FIGS. 2A-2J are exemplary screen shots, as seen by an end-user on a client computer, illustrating a download process in accordance with an embodiment of the present invention;

FIG. 3A schematically illustrates a first stage software in accordance with an embodiment of the present invention;

FIG. 3B schematically illustrates a downloadable software that is divided into a series of portions in accordance with an embodiment of the present invention;

FIG. 4 is a flowchart of a process for distributing a downloadable software in accordance with an embodiment of the present invention;

FIG. 5 is a flowchart of a process for downloading a downloadable software in accordance with an embodiment of the present invention;

FIG. 6 schematically illustrates a first stage software in accordance with another embodiment of the present invention;

FIG. 7A schematically illustrates the division of a file in chunks in accordance with an embodiment of the present invention;

FIG. 7B schematically illustrates a time domain multiplexing for downloading a file in accordance with an embodiment of the present invention;

FIG. 8 schematically illustrates exemplary files downloaded from a server computer in accordance with an embodiment of the present invention;

FIG. 9 is a flowchart of a process for downloading files in accordance with an embodiment of the present invention;

FIG. 10 is a flowchart of a process for downloading a file in chunks in accordance with an embodiment of the present invention.

FIG. 11 is a flowchart of a process for initiating a software download in accordance with an embodiment of the present invention;

FIG. 12 is a schematic representation of a process for initiating a software download in accordance with an embodiment of the present invention;

FIG. 13 is a schematic flow diagram of the embodiment of the process depicted in FIG. 12 in further detail in accordance with an embodiment of the present invention;

FIG. 14 is a schematic representation of an illustrative message displayed by the security feature of the browser application for obtaining user authorization for the downloading of the plug-in application in accordance with an embodiment of the present invention;

FIG. 15 is a schematic illustration of two possible appearances of a pop-under window displaying a license agreement in accordance with an embodiment of the present invention;

FIG. 16 is a schematic illustration of a display presented to a user after the downloaded software application has been installed on the client computer in accordance with an embodiment of the present invention;

FIG. 17 is a schematic diagram of an illustrative network system with a plurality of components in accordance with an embodiment of the present invention; and

FIG. 18 is a schematic diagram of a representative hardware environment in accordance with an embodiment of the present invention.

### DETAILED DESCRIPTION

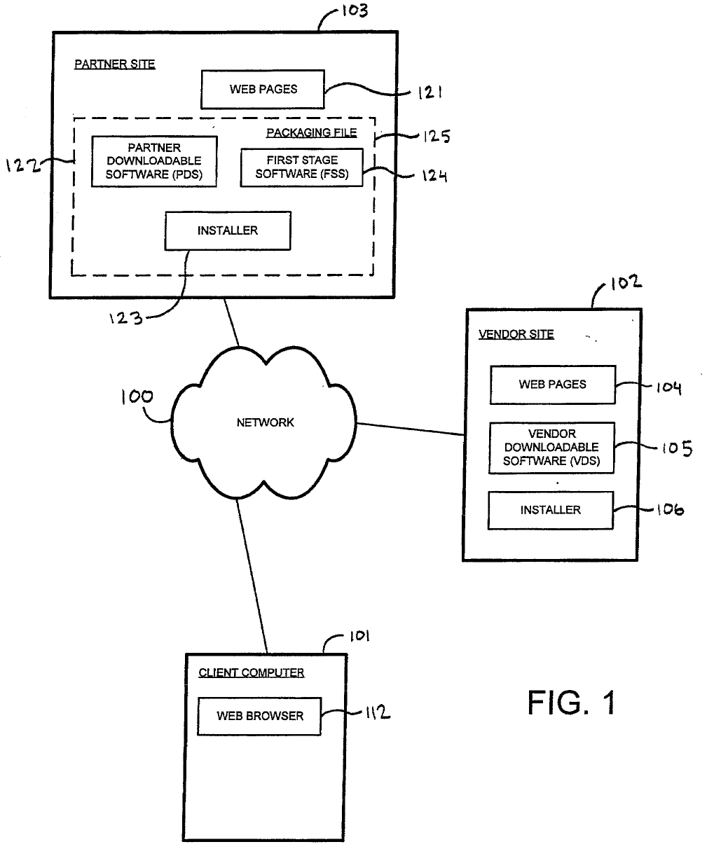

Referring to FIG. 1, there is shown a schematic diagram of a computer network in accordance with an embodiment of the present invention. A computer network 100 couples together a client computer 101, a vendor site 102, a partner site 103, and other computers not specifically shown. Network 100 may be any type of computer network; in this embodiment, network 100 is a public network such as the Internet.

Client computer 101 may be any type of computer that provides an end-user access to a network. In this embodiment, client computer 101 is a personal computer running either the Microsoft Windows™, Apple Macintosh™, Linux, or UNIX operating system. Client computer 101 includes a web browser 112 such as the Microsoft Internet Explorer™ or Netscape Navigator™. An end-user on client computer 101 employs web browser 112 to view web pages stored on various sites on network 100.

Vendor site 102 is a web site that includes web pages 104, one or more vendor downloadable software 105, and an installer 106. As can be appreciated, vendor site 102, and other sites in the present disclosure, may be implemented using a server computer such as those available from Sun Microsystems™, the Hewlett-Packard Company™, or International Business Machines™. Web pages 104 contain information that can be viewed over network 100 using a web browser. For example, web pages 104 may contain news, maps, coupons, free services, directories, and other types of information that will attract end-users to vendor site 102. As shown in FIG. 1, a vendor downloadable software (VDS) 105 is available for download from vendor site 102. VDS 105 may be any type of software including application software. For example, VDS 105 may be a screen saver, a video game, a device driver, music, wallpaper, electronic book, or software for filling out electronic forms and login screens on the Internet. VDS 105, and other downloadable software in the present disclosure, may be stored on vendor site 102 or on another site linked thereto. VDS 105, and other downloadable software in the present disclosure, may consist of a single file or a group of files.

For various reasons, it is desirable to have end-users download VDS 105. One reason may be that end-users employing VDS 105 will have to pay licensing fees. Another reason may be that the use of VDS 105 in an end-user's computer allows for some form of advertising. Another reason may be that the vendor operating vendor site 102 charges another vendor, who happens to own VDS 105, a fee whenever an end-user downloads VDS 105. Whatever the reason, it is desirable to distribute VDS 105 to as many end-users as possible.

Installer 106 is also available for download from vendor site 102. Installer 106 assists the end-user in installing and configuring the various VDS 105 available from vendor site 102. Installer 106 may be downloaded separately as depicted in FIG. 1, or as part of a VDS 105. That is, installer 106, and other installers in the present disclosure, may also be incorporated in a corresponding VDS 105.

Partner site 103 is a web site that includes its own set of web pages (web pages 121), downloadable software (partner downloadable software 122), and installers (installer 123). To increase the exposure of VDS 105 to potential end-users, the vendor operating vendor site 102 (hereinafter referred to as “vendor”) contracts with the vendor operating partner site 103 (hereinafter referred to as “partner”) to make a first stage software (FSS) 124 available for download from partner site 103. As will be discussed below, FSS 124 facilitates the downloading of VDS 105 to any computer on network 100. Essentially, the partner agrees to offer VDS 105 to end-users viewing web pages 121 or to those who want to download a partner downloadable software (PDS) 122 from partner site 103.

PDS 122, FSS 124, and installer 123 may be contained in a packaging file 125. In this embodiment, packaging file 125 is a compressed, executable file that simplifies the download process by including all files necessary to install and run PDS 122 on a client computer. Of course, PDS 122, FSS 124, and installer 123 may also be separately stored and individually downloaded.

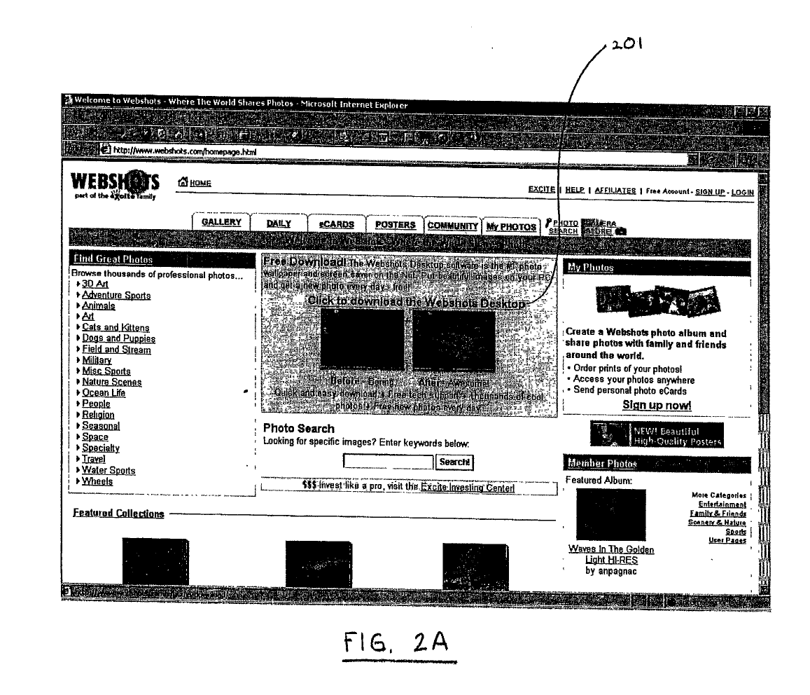

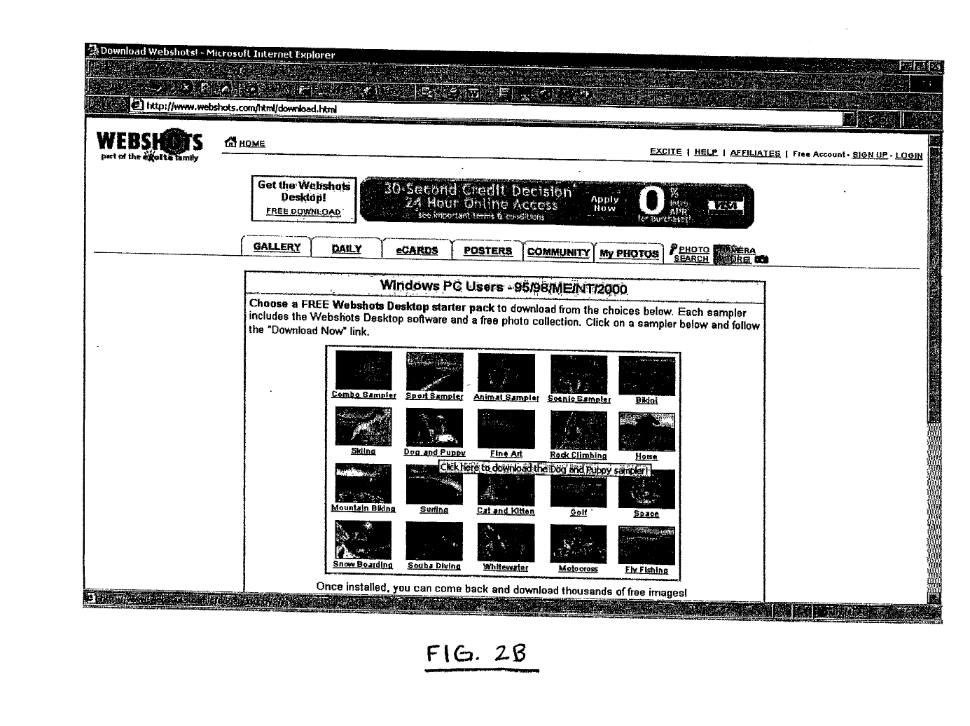

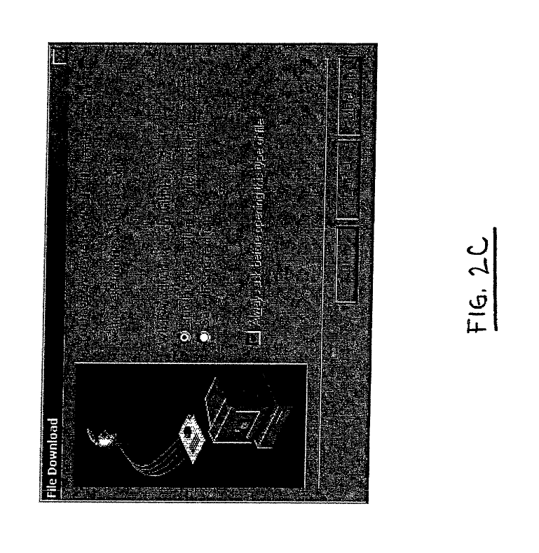

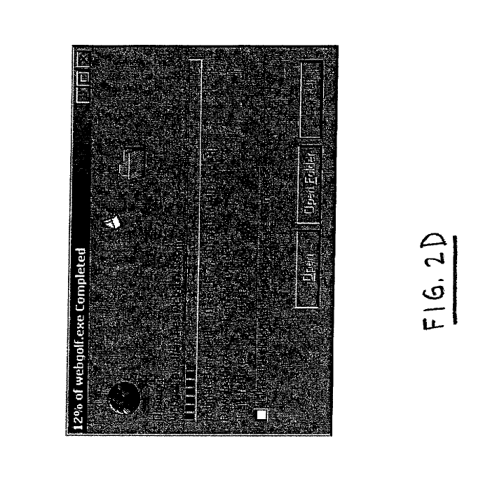

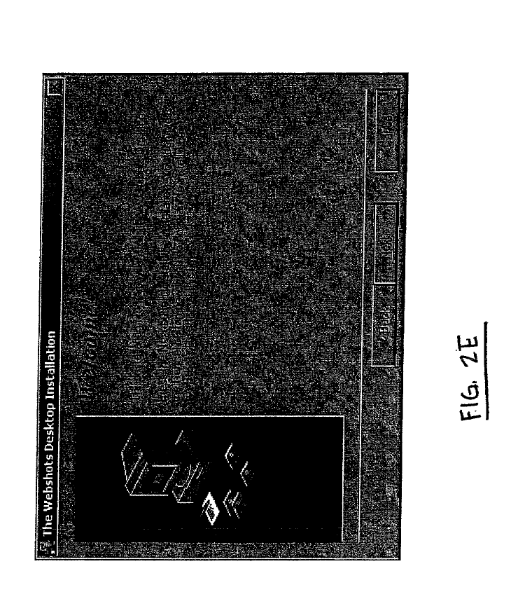

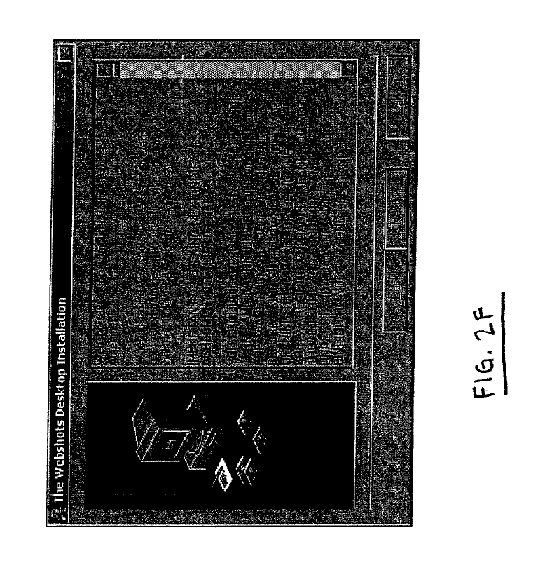

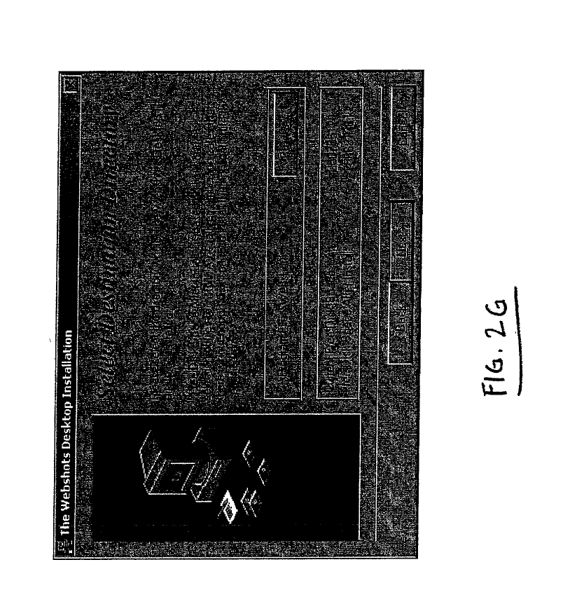

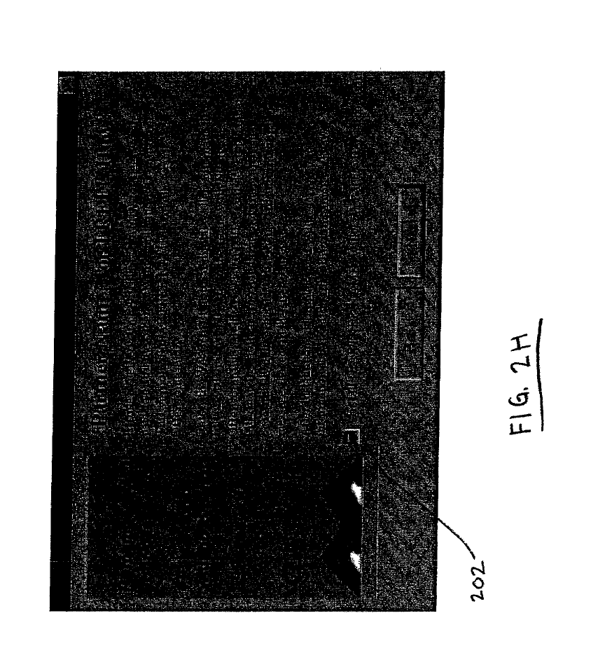

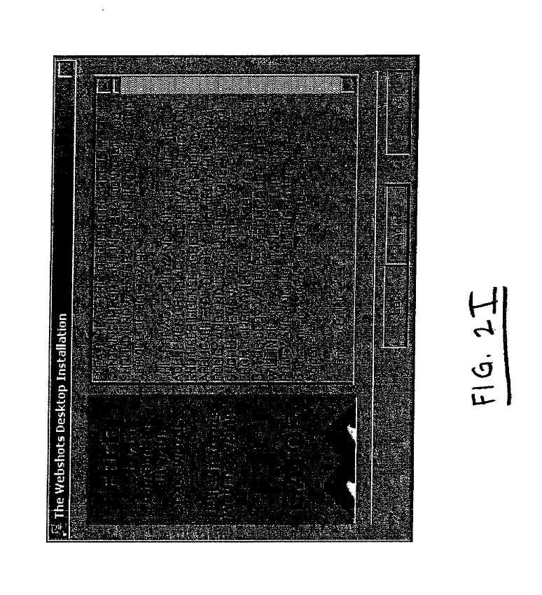

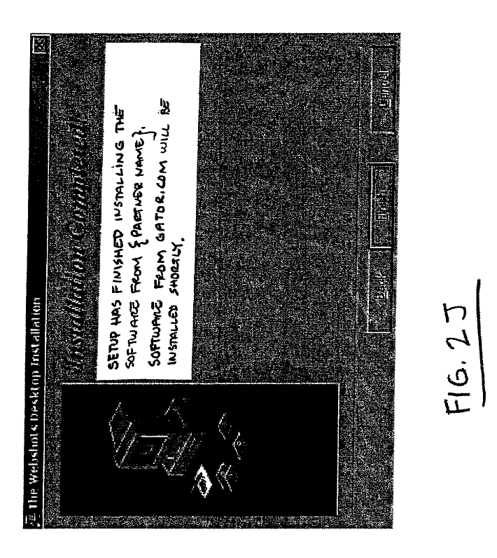

FIGS. 2A-2J are exemplary screen shots, as seen by an end-user on client computer 101, illustrating a download process in accordance with an embodiment of the present invention. Note that the screen shots of FIGS. 2A-2J are provided for illustration purposes only, and do not imply that a business relationship exists between Gator.com™, the assignee of the present disclosure, and the copyright owner of the screen shots. Furthermore, intermediate screen shots that are not necessary to the understanding of the present invention are not shown for the sake of clarity. FIG. 2A shows an example web page from a partner site 103 offering several PDS 122, which in this example are wallpapers and screen savers. Clicking on hyperlink message 201 brings up the web page shown in FIG. 2B. As shown in FIG. 2B, the end-user is provided several PDS 122 to choose from. Clicking on any selection initiates the download of a packaging file 125 containing the selected PDS 122 onto client computer 101. The packaging file 125 may be downloaded directly from partner site 103, or from another site linked to partner site 103.

In FIG. 2C, the end-user is given the option to either run the packaging file 125 from partner site 103 or save the packaging file 125 on client computer 101. Choosing the save option results in the downloading of the packaging file 125 onto client computer 101, and allows the end-user to run the packaging file 125 at a later time. Choosing the run from partner site 103 option results in the downloading of packaging file 125 onto client computer 101, and running of the packaging file 125 immediately after the download has completed. FIG. 2D is an example screen shot showing the downloading of the packaging file 125.

In FIG. 2E, the end-user is given the option to cancel out of the installation process. If the end-user proceeds with the installation, she is presented with a license agreement covering the use and ownership of the selected PDS 122 as shown in FIG. 2F. Otherwise, the installation process is halted. In FIG. 2G, the end-user specifies a location in client computer 101 where the selected PDS 122 is to be installed.

In accordance with the agreement between the vendor and the partner, VDS 105 is offered to the end-user as shown in FIG. 2H. The end-user agrees to get VDS 105 by placing a check mark on checkbox 202. If the end-user agrees to have VDS 105, she is presented with a license agreement covering the use and ownership of VDS 105 as shown in FIG. 21. Agreeing to the license agreement starts the installation of the selected PDS 122 and VDS 105 on client computer 101. In FIG. 2J, the end-user is notified after the completion of the installation process.

Referring again to FIG. 1, FSS 124, and not VDS 105, is bundled with PDS 122 in a packaging file 125. In this embodiment, FSS 124 is a relatively small (e.g., file size less than about 100 Kbytes when compressed) executable file that downloads VDS 105 onto any computer coupled to network 100. The relatively small size of FSS 124 makes it ideal for bundling with downloadable software on partner sites. That is, a partner is more likely to agree to bundle FSS 124 with his software than VDS 105. This is because the relatively large size of VDS 105 will slow down the downloading of the partner's PDS 122, thereby increasing the likelihood of end-users prematurely canceling the download process or encountering a transmission error in midstream. The more partners agree to bundle FSS 124 with their downloadable software, the more VDS 105 will get distributed to end-users.

Bundling FSS 124 with PDS 122 also simplifies the distribution process. Because FSS 124 is not an inherent part of VDS 105, and merely downloads a specific file (or files) from vendor site 102, VDS 105 can be updated without having to update FSS 124. Additionally, the size of FSS 124 can be kept relatively small regardless of the size or number of VDS 105 to download.

In another embodiment, the partner's software is distributed on removable storage medium such as a CD-ROM, for example. In that case, VDS 105 is offered to the end-user during the installation of the partner's software. If the end-user accepts, FSS 124 is copied from the CD-ROM to the end-user's computer, and then run to download VDS 105 off vendor site 102.

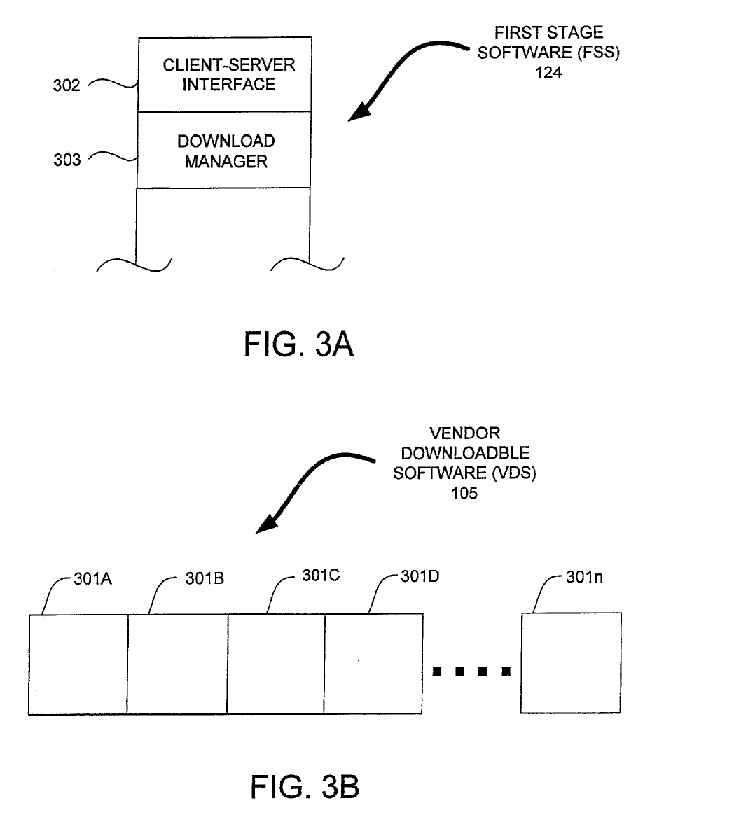

FIG. 3A schematically illustrates an FSS 124 in accordance with an embodiment of the present invention. As shown in FIG. 3A, an FSS 124 includes a client-server interface 302 and a download manager 303. Client-server interface 302 allows an FSS 124 running on a client computer 101 to communicate with a vendor site 102, which is a server computer in this embodiment. Client-server interface 302 includes computer instructions for client-server communication, checking-in with vendor site 102, and authentication. The information passed-on by FSS 124 to vendor site 102 upon checking-in includes the identity of the partner site it came from (e.g., for billing purposes) and its version number.

As shown in FIG. 3A, an FSS 124 also includes a download manager 303 for downloading one or more VDS 105 from vendor site 102 or from another site linked to vendor site 102. Download manager 303 obtains the names of VDS 105 to download and their respective locations. Download manager 303 includes computer instructions for copying a VDS 105 from its location in vendor site 102 (or another site linked thereto) onto a location in client computer 101. Download manager 303 may download a single file containing the entirety of a VDS 105, or a series of small portions each containing a portion of the VDS 105.

FIG. 3B schematically illustrates a VDS 105 that is divided into a series of small portions, each of which is referred to herein as a chunk 301 (i.e., 301A, 301B, . . 301n), in accordance with an embodiment of the present invention. In that embodiment, download manager 303 downloads chunks 301 individually, one after another. That is, download manager 303 first downloads chunk 301A onto client computer 101, then chunk 301B, then chunk 301C, and so on. After all chunks 301 have been downloaded on client computer 101, download manager 303 then reassembles the chunks 301 into a VDS 105. Reassembly of the chunks 301 in client computer 101 may be performed several ways. For example, chunk 301A, the first chunk to be downloaded by download manager 303, could be designated as a control chunk and include information for assembling chunks 301B, 301C, 301D . . . 301n together. Chunk 301A could also include a more sophisticated (and larger) set of computer instructions for downloading the rest of VDS 105. Another way is to include headers in each chunk 301, with each header having reassembly information such as the order number of the current chunk, and the respective order numbers of the preceding and following chunks. In that case, the headers are removed by download manager 303 as the chunks are reassembled in client computer 101. As can be appreciated, other ways of downloading a piece of software in chunks can also be used without detracting from the merits of the present invention. It is to be noted that techniques for dividing a piece of software into a series of small portions, individually downloading each portion onto a computer, and reassembling the piece of software in the computer (also known as “trickling”), in general, are known in the art.

Download manager 303 can be configured to download each chunk 301 depending, for example, on the amount of available bandwidth in the network connection of client computer 101, the time of day, or the need of the end-user. For example, download manager 303 can be configured to download one chunk 301 at a time if the network connection is a 28 KBPS dial-up connection, or three chunks 301 at a time if the network connection is a T1 line. As another example, download manager 303 can be configured to download the chunks 301 over a span of one week or the next two hours. As a further example, download manager can be configured to schedule the download at the most opportune time (e.g., midnight).

As can be appreciated, the flexibility of downloading VDS 105 in chunks makes the downloading process more reliable. Furthermore, downloading in chunks does not tie-up the client computer 101, and can be spread out in time such that the end-user barely notices that a download is in progress.

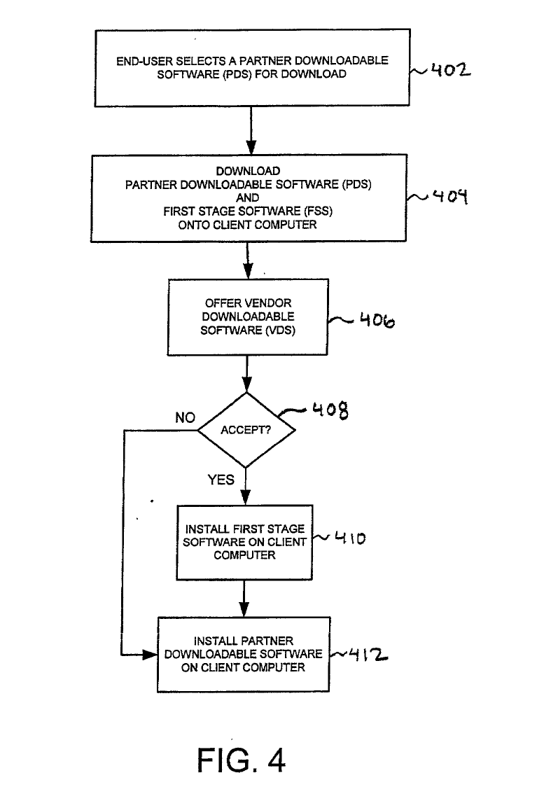

FIG. 4 shows a flowchart for a process for distributing a VDS 105 in accordance with an embodiment of the present invention. In action 402, an end-user selects a PDS 122 for download from a partner site 103. In action 404, the selected PDS 122 is downloaded from partner site 103 to the end-user's client computer 101. As part of the partner's bundling agreement with the vendor, an FSS 124 is also downloaded from partner site 103 to client computer 101 (see action 404). In action 408, the vendor's VDS 105 is offered to the end-user. If the end-user agrees to have the VDS 105, FSS 124 is installed on client computer 101, as noted in action 410. As part of its installation process, FSS 124 is decompressed (if compressed) and then automatically invoked to download the VDS 105 either as a single file or in chunks depending on implementation. In action 412, the selected PDS 122 is installed on client computer 101. Optionally, FSS 124 is deleted off client computer 101 if the end-user declines to have the VDS 105; in any event, FSS 124 is too small to have an impact on the storage capacity of client computer 101.

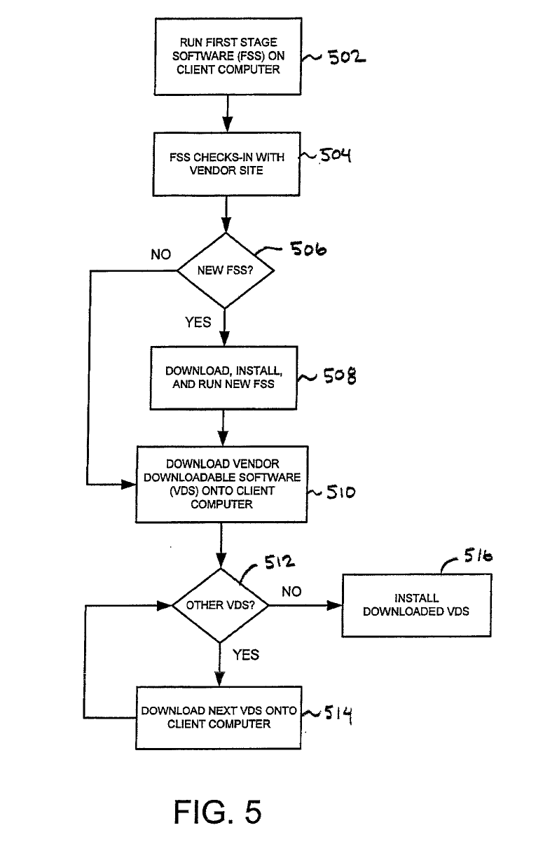

FIG. 5 shows a method for downloading a VDS 105 in accordance with an embodiment of the present invention. In action 502, a previously installed FSS 124 is run on client computer 101. In action 504, FSS 124 checks-in with vendor site 102. During the check-in process, FSS 124 is authenticated as a client authorized to download data (including files) from vendor site 102. In action 506, FSS 124 determines if a newer version of FSS 124 is available. If so, the new FSS 124 is downloaded on client computer 101 and run instead of the old FSS 124, as noted in action 508.

In action 510, FSS 124 downloads the VDS 105 onto client computer 101. The VDS 105 is either downloaded as a single file or in chunks depending on implementation. Additionally, other software for supporting VDS 105 (e.g., an installer if one is not included in VDS 105) are also downloaded at this time. In action 512, FSS 124 determines if there are other VDS 105 offered to and selected by the end-user. If so, FSS 124 proceeds to download each of them, as noted in action 514. In action 516, all downloaded VDSs 105 are installed on client computer 101.

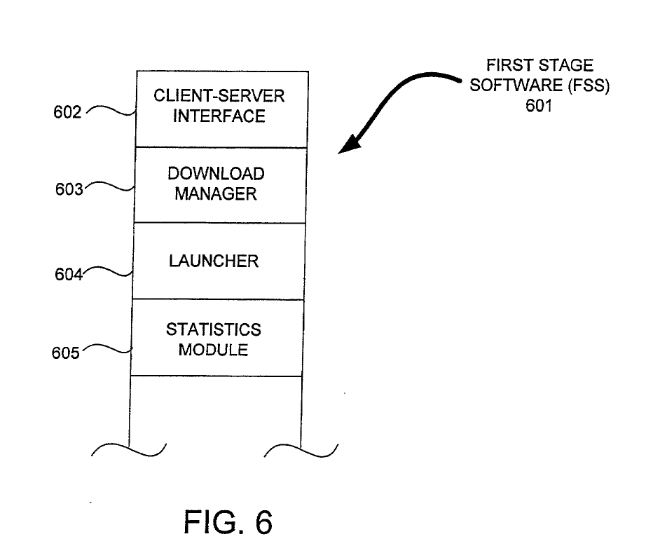

Referring now to FIG. 6, there is shown a schematic representation of a first stage software (FSS) 601, in accordance with another embodiment of the present invention. FSS 601 is a relatively small (e.g., 100 Kbytes when compressed) piece of software that facilitates the downloading of files to a client computer. FSS 601 runs in a client computer such as client computer 101. FSS 601 may be bundled with a partner software downloadable from a server computer or partner software distributed on removable storage media. It should be understood, however, that FSS 601 may be used in any application requiring downloading of files, and not necessarily limited to software bundling applications.

FSS 601 includes a client-server interface 602, a download manager 603, a launcher 604, and a statistics module 605. Client-server interface 603 includes computer instructions that allow FSS 601 to communicate with a server computer such as vendor site 102.

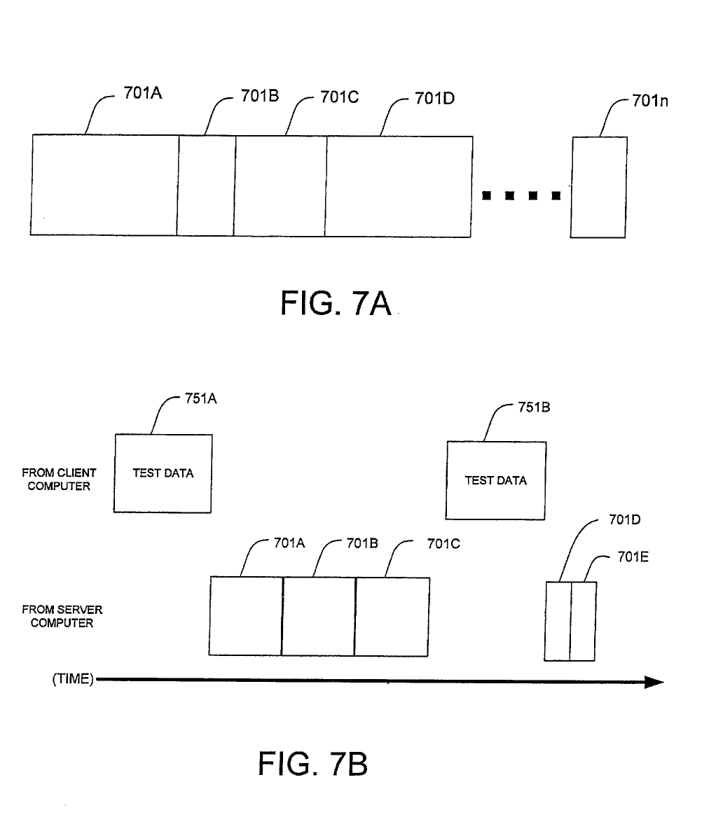

A download manager 603 includes computer instructions for downloading one or more files (e.g., VDS 105 and support software) from a server computer to a client computer running FSS 601. In this embodiment, download manager 603 downloads files using the Hypertext Transfer Protocol (HTTP). Download manager 603 may download a single file in its entirety, or download a single file in small portions. This aspect of the present invention is now described in connection with FIG. 7A.

In FIG. 7A, chunks 701A, 701B, 701C, . . . 701n compose a single file. Using HTTP, download manager 603 asks the server computer to download specific portions of the single file. For example, download manager 603 may ask the server for bytes 1 to 500 of VDS 105 and designate that portion as chunk 701A, for bytes 501 to 532 of VDS 105 and designate that portion as chunk 701B, for bytes 533 to 600 of VDS 105 and designate that portion as chunk 701C, etc. The size of each chunk may be varied by varying the byte range. Thus, download manager 603 has the capability to download a single file in chunks. If there are several files to download, each file is downloaded in chunks until all the files are downloaded.

FIG. 7B schematically illustrates a time domain multiplexing technique employed by download manager 603 in accordance with an embodiment of the present invention. In this embodiment, download manager 603 periodically transmits a test data 751 (i.e., 751A, 751B) to get an indication of the amount of bandwidth available on the network connection between the server computer and the client computer running FSS 601. A test data 751 may be any block of data of known size. Download manager 603 transmits a test data 751 to the server computer, and then determines the time it takes for the just transmitted test data 751 to reach the server computer. The amount of time it takes to transmit a test data 751 will vary depending on the size of the test data 751, and the amount of bandwidth available between the server computer and the client computer running FSS 601. During periods when the network connection to the client computer is being heavily utilized, e.g., when the end-user is engaged in Voice over IP communication or playing an on-line video game, it will take more time to transmit the test data 751. Conversely, it will take less time to transmit the test data 751 during periods when the client computer is idle.

From the foregoing, the transmission of a test data 751 enables download manager 603 to determine the amount of bandwidth currently being consumed by the end-user. This allows download manager 603 to adjust the size of each chunk 701 and the amount of time to be used in downloading a series of chunks 701 such that the end-user barely notices that a download to her client computer is in-progress. Referring to FIG. 7B as an example, after download manager 603 transmits test data 751A from the client computer and gets an indication of how much bandwidth is currently being consumed by the end-user, download manager can then request the server computer to download appropriately sized chunks 701 for a certain period of time (e.g., download chunks 701, each having a size of 500 bytes, for 8 seconds). After all requested chunks 701 have been received in the client computer, download manager 603 can then send another test data 751 to determine network traffic, and accordingly request appropriate sized chunks, transmitted for a certain period of time, and so on.

Download manager 603 further includes computer instructions for keeping track of the chunks 701 already downloaded to the client computer. This allows download manager 603 to determine the last chunk 701 successfully downloaded, which is useful information in case of a download error (e.g., due to a connection failure). In that case, download manager 603 may be restarted to download the next chunk following the last successfully downloaded chunk 701, rather than having to begin the download process again from the very beginning.

Download manager 603 further includes computer instructions for reassembling all the downloaded chunks 701 in the client computer.

As can be appreciated, downloading a single file in chunks in accordance with this embodiment of the present invention increases the likelihood of successfully completing a download, minimizes the impact of the download process on the end-user, and allows for download using slow network connections.

Referring again to FIG. 6, FSS 601 further includes a launcher 604 for running software downloaded by download manager 603. Statistics module 605 keeps track of statistical information relating to the use of FSS 601. In one embodiment, statistics module 605 includes computer instructions for keeping track of the number of times a specific piece of software has been downloaded from the server, the number of successful and unsuccessful downloads, error codes relating to unsuccessful downloads, the identity of the partner who bundled FSS 601, etc. Such information allows the partner to be paid (or billed) for every successful download and enables software developers to optimize the download process, for example.

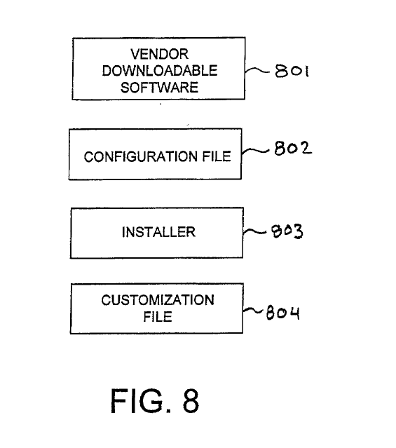

FIG. 8 schematically illustrates exemplary files downloaded by FSS 601 from a server computer in accordance with an embodiment of the present invention. In addition to a vendor downloadable software (VDS) 801, FSS 601 also downloads a configuration file 802, an installer 803, and a customization file 804.

In one embodiment, configuration file 802 is the first file downloaded by FSS 601. Configuration file 802 includes a list of files that would have to be downloaded from the server computer. In this embodiment, configuration file 802 includes the file name and location of VDS 801, installer 803, and customization file 804. Additional files may also be added to the list. As can be appreciated, configuration file 802 allows VDS 801, and its support files, to be updated without having to update FSS 601. This is a specially useful in situations where FSS 601 has been provided to a lot of vendors who have already bundled FSS 601 with their respective software.

Configuration file 802 further includes a bandwidth utilization value. In this embodiment, the bandwidth utilization value indicates the amount of bandwidth that download manager 603 should consume in downloading files. For example, if the desired bandwidth utilization is 15%, download manager 603 would adjust the size of the chunks and/or the amount of time used in downloading a series of chunks such that only approximately 15% of the available bandwidth on the network connection between the client computer and the server computer is utilized.

Referring again to FIG. 8, FSS 601 also downloads an installer 803 from the server computer. Installer 803 includes computer instructions for installing software downloaded to the client computer running FSS 601.

FSS 601 may also download a customization file 804 from the server computer. In this embodiment, customization file 804 contains dynamic link library (DLL) data for customizing a partner's user interface (e.g., user interface for installation of partner downloadable software). This allows each partner to have a unique look and feel for his software although all partners offer the same VDS 801 to their respective customers.

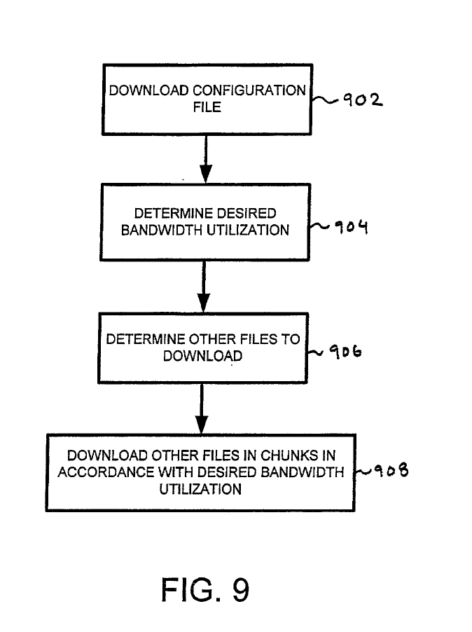

FIG. 9 shows a flowchart of a process for downloading files in accordance with an embodiment of the present invention. In action 902, download manager 603 downloads a configuration file 802. In action 904, download manager 603 determines the desired bandwidth utilization by reading a bandwidth utilization value indicated in the configuration file 802. In action 906, download manager 603 determines all the files needed to be downloaded from a list in the configuration file 802. In action 908, download manager 603 downloads all the files needed to be downloaded in chunks.

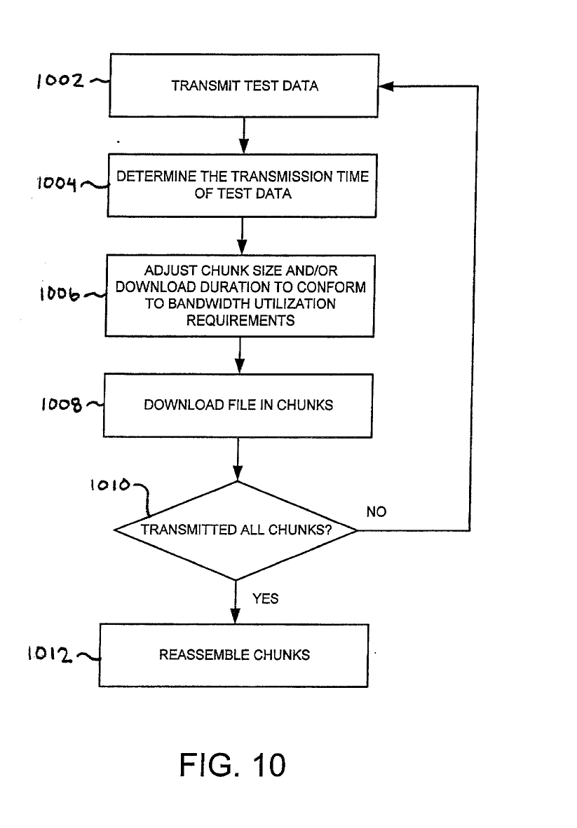

FIG. 10 shows a flowchart of a process for downloading a file in chunks in accordance with an embodiment of the present invention. In action 1002, download manager 603 transmits a test data to the server computer containing the file to be downloaded. In action 1004, download manager 603 determines the transmission time of the test data.

In action 1006, download manager 603 adjusts the size of each chunk of the file to be downloaded and/or the amount of time used in downloading a series of chunks (i.e., download duration) in order to conform to a desired bandwidth utilization. For example, if the desired bandwidth utilization is 20% of the available bandwidth of the network connection.

In action 1008, download manager 603 transmits an appropriately sized chunk or series of chunks for a certain period of time dictated by the desired bandwidth utilization. In action 1010, the aforementioned actions are repeated until all chunks of the file have been downloaded. In action 1012, the chunks are reassembled in the client computer after all the chunks have been downloaded.

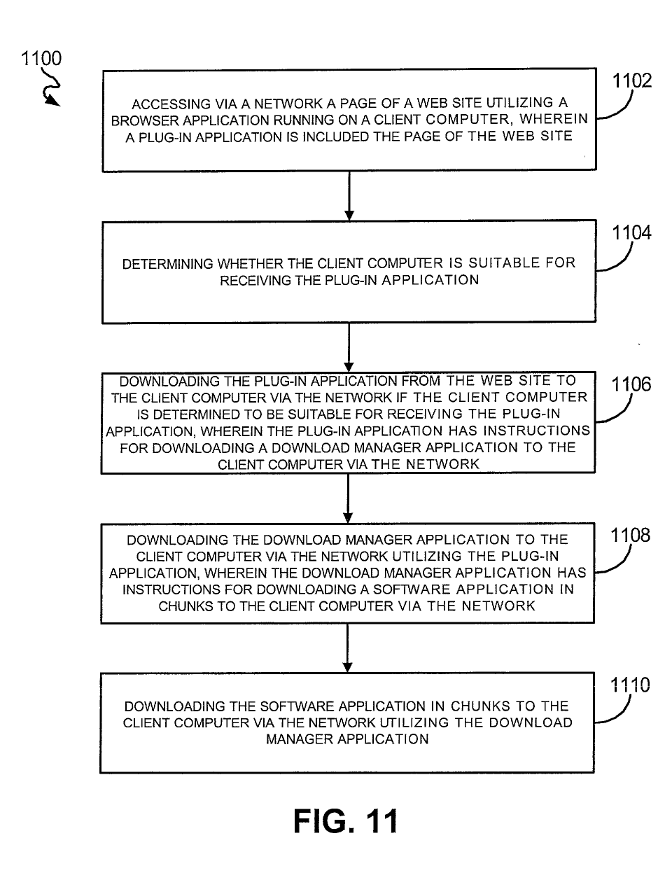

FIG. 11 is a flowchart of a process 1100 for initiating a software download in accordance with an embodiment of the present invention. In operation 1102, a page of a web site (e.g., a partner's web site) is accessed via a network (e.g., the Internet or World Wide Web) by a user utilizing a browser application running on a client computer. A plug-in application is included (i.e., resides in) the page of the web site. In operation 1104, it is determined whether the client computer is suitable or eligible for receiving the plug-in application (i.e., that the client computer meets certain requirements or criteria).

If the client computer is determined to be suitable/eligible for receiving the plug-in application, then the plug-in application is downloaded from the web site to the client computer via the network in operation 1106. This plug-in application has instructions for downloading a download manager application to the client computer via the network.

The download manager application is subsequently downloaded to the client computer via the network utilizing the plug-in application in operation 1108. In one embodiment, the download manager application is download from another (or second) web site (e.g., a vendor's web site) than that in which the plug-in application resides. The download manager application has instructions for downloading a software application in chunks (i.e., individually downloadable portions) to the client computer via the network. In operation 1110, the software application is then downloaded in chunks (i.e., individually downloadable portions) to the client computer via the network utilizing the download manager application. In one embodiment, the software application may be downloaded from a web site other than the first accessed web site such as, for example, the vendor's web site.

In an embodiment of the present invention, the plug-in application may comprise an ActiveX control and/or a JavaScript application. In another embodiment, a security feature of the browser application of the client computer may require that a user authorize the downloading of the plug-in application. In such an embodiment, the security feature may include displaying a message (e.g., a pop-up type a security warning message such as that known in the art as a VeriSign prompt) to the user that notifies the user to authorize the downloading of the plug-in application. The message may also provide information about the plug-in application such as the name and/or source of the plug-in application. As another option, another page of the web site may be displayed to the user (i.e., the user is redirected to another page) if the authorization to download the plug-in application is denied by the user (and thus the downloading of the plug-in application does not occur). In such an embodiment, this page may include (i.e., display) more information for the user about the vendor, the plug-in application, the download manager application, and/or the software application. As a further option, the user may be redirected to another web site such as, for example, the vendor's web site or a third party's web site.

As a further option in such an embodiment, information about whether or not the downloading of the plug-in application was authorized by the user may be stored in the client computer. For example, such information may be stored in the client computer in a cookie so that this information can utilized each subsequent time the client computer accesses the web site to determine the suitability of downloading the plug-in application to the client computer.

In yet another embodiment of the present invention, determining the suitability of the client computer for receiving the plug-in application may include determining whether the number of times the client computer has accessed the web site (i.e., frequency of visits) is under a predetermined threshold number. In a further embodiment, another page of the web site may be displayed on the if the client computer is determined to be unsuitable for receiving the plug-in application. In an additional embodiment, a license agreement may be displayed on the client computer to the user prior to the downloading of the plug-in application. In one such embodiment, the license agreement may displayed in a window such as a pop-under window.

In even a further embodiment, the determination of the suitability of the client computer for receiving the plug-in application may be carried out by another web site, such as the vendor's web site for example. In another embodiment, the page of the web site launches a window (e.g., a pop-off window) which initiates the determination of the suitability of the client computer for receiving the plug-in application. In one such embodiment, this window may have a pointer to vendor's web site. In such an embodiment, the determination of the suitability of the client computer for receiving the plug-in application by the vendor's web site may be carried out by first receiving an affiliate code associated with the partner's web site from the pop-off window which identifies the partner's web site to the vendor's web site, checking the client computer to determine whether the client computer has a suitable browser application and operating system for receiving the plug-in application, determining whether Java script is enabled on the client computer, and reading information from an associated cookie on the client computer to determine the number of times the user and/or client computer has accessed the partner web site.

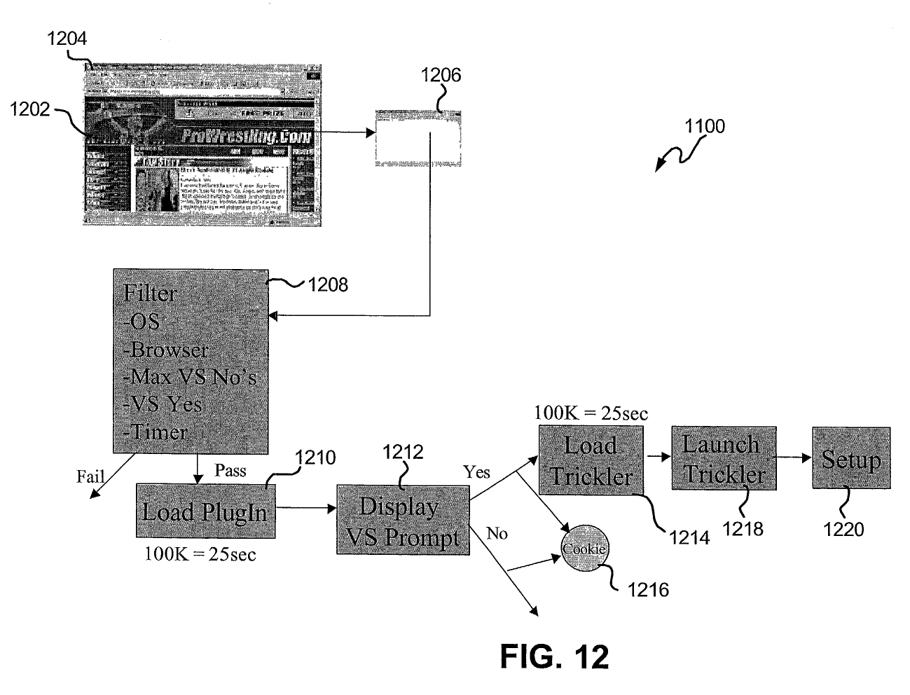

FIG. 12 is a schematic representation of the process 1100 for initiating a software download in accordance with an embodiment of the present invention. In this embodiment, when accessed via the network, the page of the web site displayed on the user's browser application 1204 running on a client computer, the plug-in application in the page launches a pop-off window 1206. The pop-off window 1206 is positioned to a side of the browser application 1204 and is not seen by the user (except for an indication on the task bar of the client computer display. The pop-off window 1206 includes a pointer to a URL of a site coupled to the network such as the vendor's site so that a filter application 1208 residing there may then be executed to determine whether the client computer is suitable or eligible for receiving the plug-in application (i.e., that the client computer meets certain requirements or criteria). In this embodiment, the filter application may perform an eligibility check that checks to see if the client computer is using an operating system and browser that are suitable for the plug-in application. The filter application may also compare information about the number of times the user has accessed the page (by checking a cookie on the client computer for example) with a frequency cap which limits the number of times a download of the plug-in can be attempted for that particular user. This comparison may also include a determination of the number of times that the user has granted or refused authorization for downloading the plug-in application during past visits to the web site. A timer may also be included to delay the launching of the plug-in application.

If the client computer is determined to be suitable/eligible for receiving the plug-in application, then loading of the plug-in application 1210 to the client computer may be initiated. In a preferred embodiment the plug-in application 1210 may comprise an ActiveX control and have a size of about 100K. Loading of the plug-in application may then trigger a security feature 1212 of the browser application of the client computer which requires that a user authorize the downloading of the plug-in application. In such an embodiment, the security feature may include displaying a message (e.g., a pop-up type a security warning message such as that known in the art as a VeriSign prompt (“VS Prompt” in FIG. 12) to the user that notifies the user to authorize the downloading of the plug-in application.

If the user authorizes the loading of the plug-in application (i.e., “Yes” path after 1212), the plug-in application is downloaded to the client computer and then used to download the download manager application 1214 (also known as the trickier application) to the client computer via the network. Information about the user's allowing (or refusal) of the downloading may also be stored in a cookie 1216 in the client computer for use by the filter application in determining whether its is suitable to launch the plug-in application in subsequent visits by the user to the web site 1202.

Once downloaded to the client computer, the download manager may be utilized to download a software application in chunks (i.e., individually downloadable portions) to the client computer via the network (see block 1218). Once the software application has been completely downloaded to the client computer, the software application is then installed on to the client computer and a setup routine 1220 for configuring the software application may be executed.

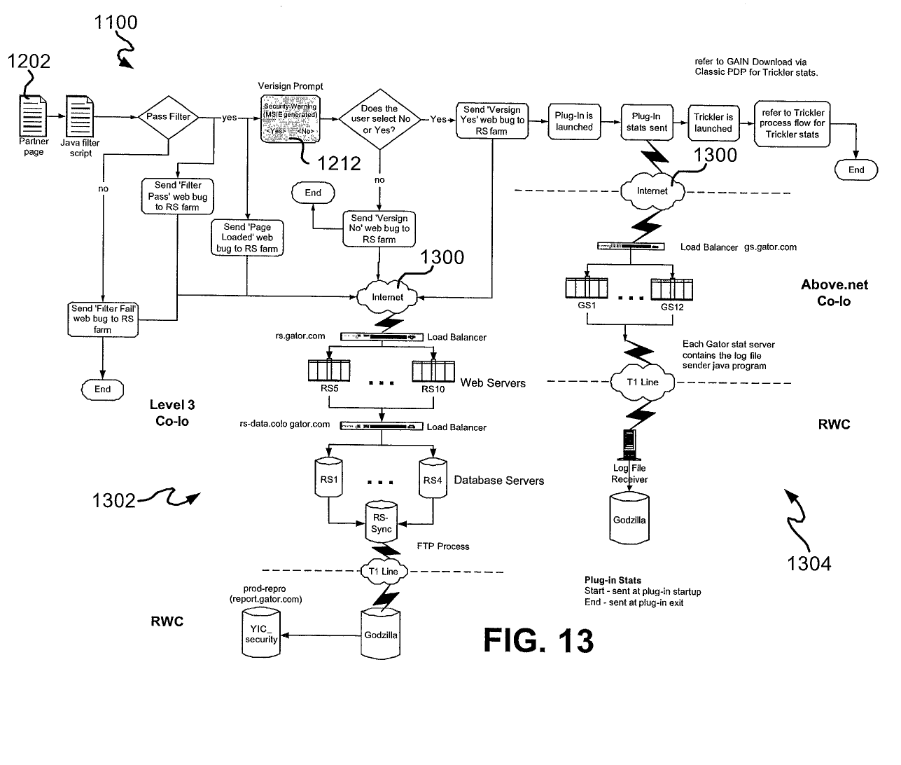

FIG. 13 is a schematic flow diagram of the embodiment of the process 1100 depicted in FIG. 12 in further detail in accordance with an embodiment of the present invention. In particular, FIG. 13 illustrates the process flow from the access of the page of the web site 1202, triggering of the security feature 1212, and network 1300 access and communication between elements of the system. Also illustrated in FIG. 13 is an embodiment of a back end system 1302 for facilitating the downloading of the software application in accordance with an embodiment of the process 1100.

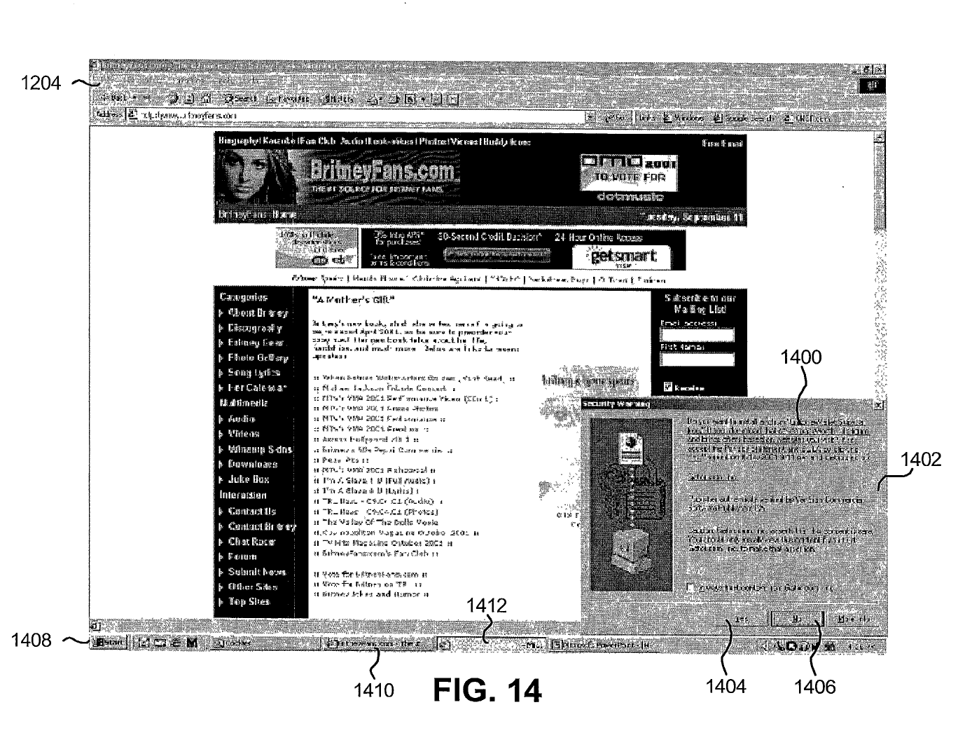

FIG. 14 is a schematic representation of an illustrative message 1400 displayed by the security feature of the browser application 1204 for obtaining user authorization for the downloading of the plug-in application in accordance with an embodiment of the present invention. In the embodiment illustrated in FIG. 14, the message 1400 of the security feature is displayed in a pop-up type window 1402 known in the art as a VeriSign prompt. The VeriSign prompt 1402 includes selections 1404, 1406 for permitting the user to authorize or deny the downloading of the plug-in application to the client computer (e.g., selection “Yes” 1404 to authorize the download and selection “no” 1406 to deny the download). As previously discussed, the message 1400 may also provide information about the plug-in application such as the name and/or source of the plug-in application. In one embodiment, the information for the message may be provided by the plug-in application. FIG. 14 also shows a task bar 1408 of the client computer that displays a box 1410 indicating the running of the browser application 1204 and a box 1412 indicating the running of pop-off window 1206.

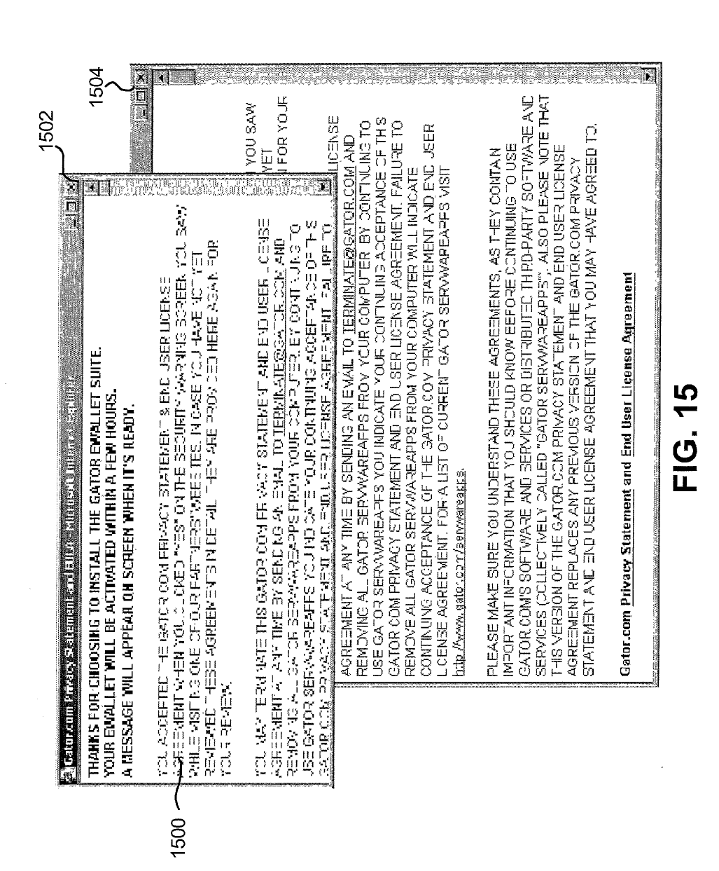

FIG. 15 is a schematic illustration of two possible appearances of a pop-under window displaying a license agreement 1500 in accordance with an embodiment of the present invention. The license agreement may be displayed on the client computer to the user prior to the downloading of the plug-in application. In a preferred embodiment, the license agreement 1500 may displayed in a smaller-sized pop-under window 1502 that may be selectively expanded to an larger sized pop-under window 1504.

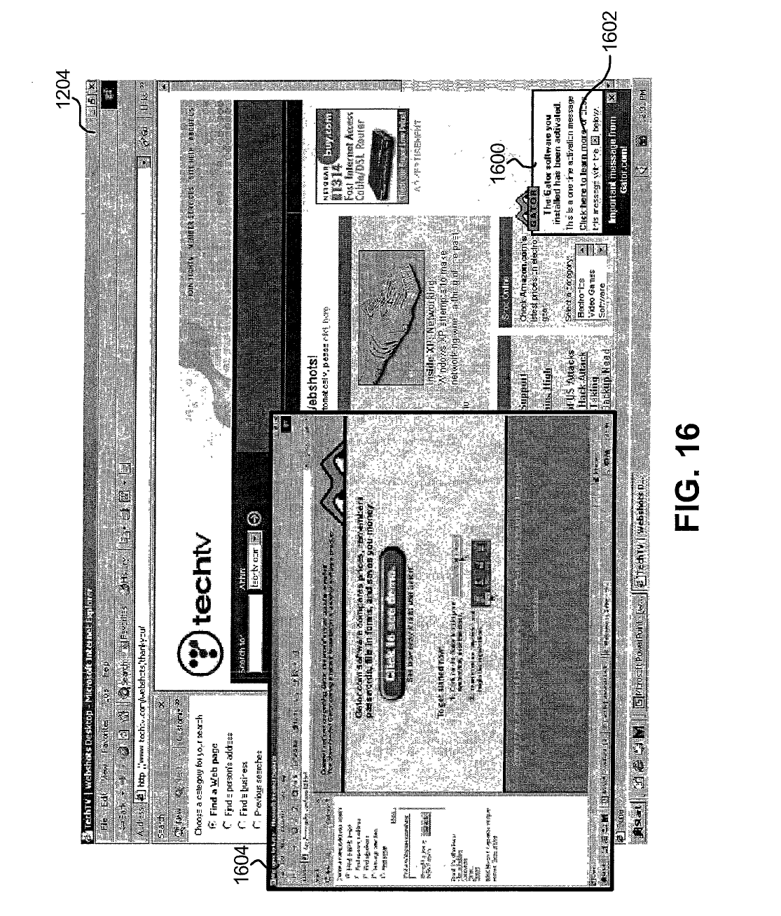

FIG. 16 is a schematic illustration of a display presented to a user after the downloaded software application has been installed on the client computer in accordance with an embodiment of the present invention. In this embodiment, once the software application has been installed (see FIG. 12, element 1220), a window 1600 is displayed to the user over the browser application 1204. This window 1600 may include an information link 1602 that, when selected, displays another window 1604 in which a demo may be presented for informing the user about the software application.

In accordance with a preferred embodiment of the present invention, the plug-in application may be implemented within its own pop-up window. For a partner to use plug-in application on their site, the partner may need to execute some JavaScript within the HTML of any page(s) on their site that will open a separate window containing the page with the plug-in application. A way of accomplishing this is making a call to the JavaScript function window.open( ) with the vendor's website URL as the URL parameter. The URL used may be in the following format:

http ://PARTNER-HOST/webpdp_v2_detect.php?yic=PARTNER-CODE

where:

PARTNER-HOST is the Hostname assigned to the partner.

PARTNER-CODE is the plug-in application code assigned to the partner.

An illustrative example of such a format is:

The Partner Host is “webpdp.gator.com”

The Partner Code is “YIC_HIC_Site_Home”

Using the above example attributes of a plug-in application URL, a call to window.open( ) may look like:

<script language=“JavaScript1.2”>
window.open(‘http://webpdp.gator.com/webpdp_v2_detect.php?yic=YIC_HIC_Site_Home’);
</script>

A pop-off window is basically a pop-up window that positioned just barely off the user's screen. To position the window off the user's screen, JavaScript's screen object may be used when setting the position coordinates (top & left) of the popped window, using window.open( ). As an example, the script below, when included in an HTML document, will launch a 250-pixel by 250-pixel window, containing www.gator.com, located 1 pixel beyond the bottom boundary of the user's screen, and horizontally centered:

<script language“JavaScript1.2”>

var pos_left = (screen.width/2) − 125; // window horizontally centered, roughly
var pos_top = (screen.height) + 1; // window is 1 pixel below the bottom of screen
var URL = “http://www.gator.com”;
window.open(URL, ‘gatorWin’,‘width=250,height=250,left=‘ + pos_left +
‘,top=’ + pos_top);

</script>

This script may easily be modified to include any URL. Further flexibility with using this script may be gained by making the script a function, and calling the function from within other JavaScript code. When the pop-off window is opened, it is not in sight of the user. The only evidence of the window will be a button in the user's task bar. That button can be used to close the window (e.g., right click over the button and then click “Close”).

Visitors viewing and interacting with the plug-in application in their web browsers may generate events which may be reported events to a real-time stats farm 1304 (see FIG. 13). Some examples of events in an illustrative reporting convention include the following:

4001: The visitor has passed all the filter checks on their browser and cookie values.

4002: The visitor has been filtered by plug-in application based upon their browser's attributes or cookie values.

4011: The visitor has been presented with the VeriSign security warning, and has clicked “Yes” on the warning dialogue box, allowing the plug-in to execute.

4012: The visitor has been presented with the VeriSign security warning, and has clicked “No” on the warning dialogue box, or closed the dialogue box, not allowing the plug-in to execute.

The filtering process that results in either of the before-mentioned 4001 or 4002 event identifiers is a series of checks on the visitor's browser attributes and cookie values. 4002 events can be examined at a more granular level, identifying at which step in the filtering process a visitor was filtered. 4002 events may be accompanied by a reason identifier which is not sent to any reporting facility. They can merely be extracted from the web servers' access logs. Some illustrative examples of such unreported events include the following:

5001: The browser does not identify itself as running on MS Windows.

5002: The browser does not identify itself as MS Internet Explorer.

5003: The browser does not identify its version as being V<6.0 and V>4.0.

5004: The browser is not functioning as if JavaScript is enabled.

5005: The browser is not functioning as if Cookies are enabled.

6001: A GatorWebPdpCookie_<HIC> cookie's value is set to the maximum allowable visit limit for the partner whose code is <HIC>

6002: The GatorWebPdpCookie_total cookie's value is set to the maximum allowable visit limit for all visits across all partners.

6003: The GatorWebPdpCookie_PluginHasRun cookie's value indicates that this user has executed the plug-in previously.

6004: The GatorWebPdpCookie_PluginTimer cookie's value indicates that the minimum amount of time has not passed for the visitor to be eligible to be presented the plug-in again.

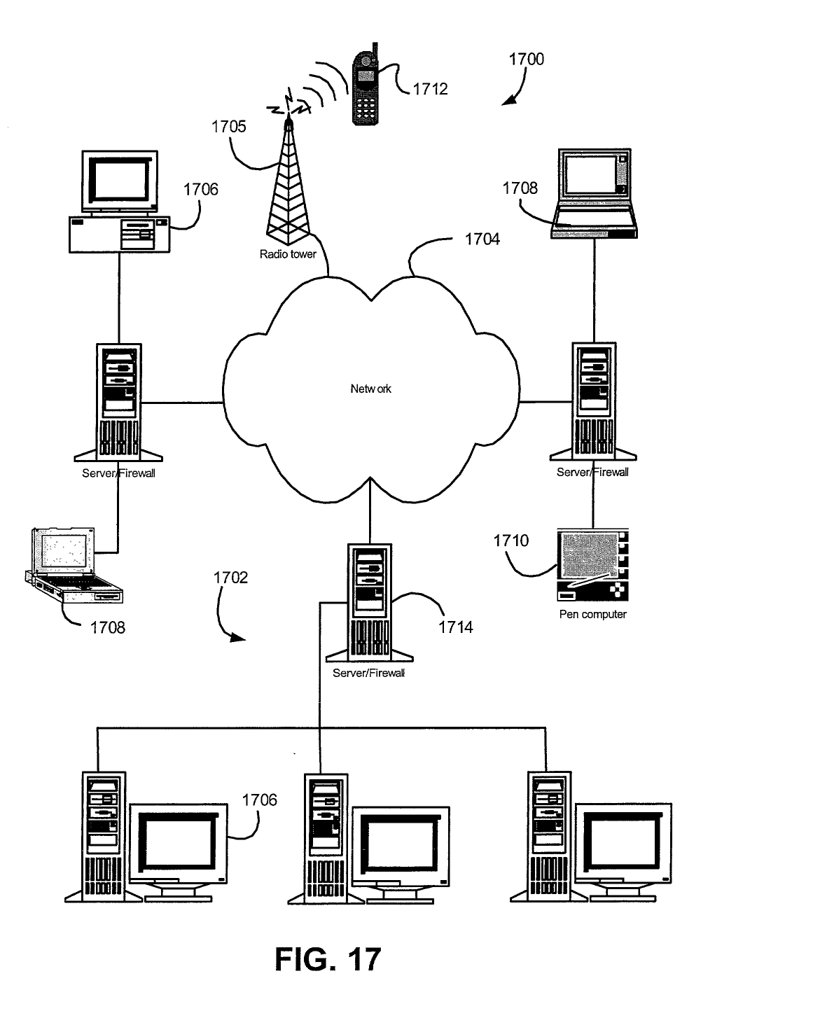

FIG. 17 illustrates an exemplary network system 1700 with a plurality of components 1702 in accordance with one embodiment of the present invention. As shown, such components include a network 1704 which take any form including, but not limited to a local area network, a wide area network such as the Internet, and a wireless network 1705. Coupled to the network 1704 is a plurality of computers which may take the form of desktop computers 1706, lap-top computers 1708, hand-held computers 1710 (including wireless devices 1712 such as wireless PDA's or mobile phones), or any other type of computing hardware/software. As an option, the various computers may be connected to the network 1704 by way of a server 1714 which may be equipped with a firewall for security purposes. It should be noted that any other type of hardware or software may be included in the system and be considered a component thereof.

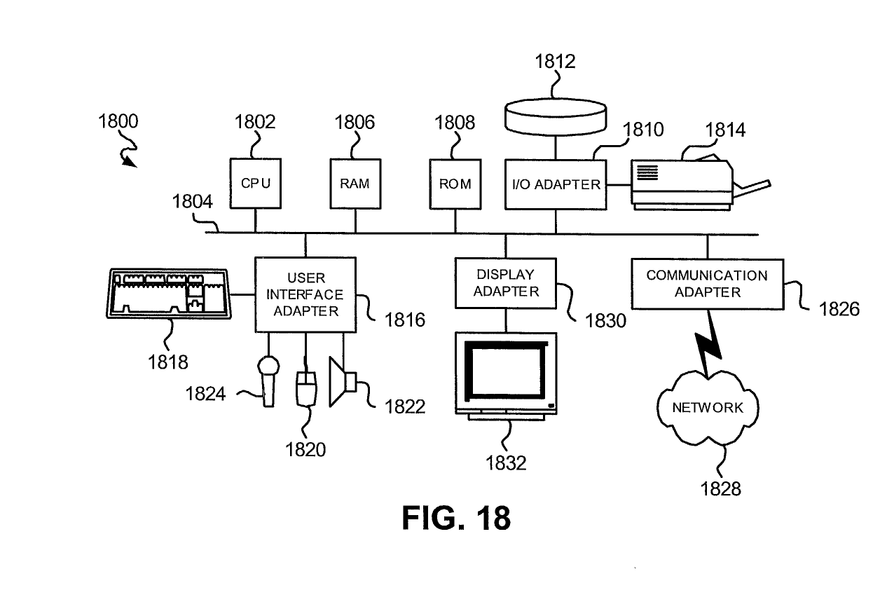

A representative hardware environment associated with the various components of FIG. 17 is depicted in FIG. 18. In the present description, the various sub-components of each of the components may also be considered components of the system. For example, particular software modules executed on any component of the system may also be considered components of the system. In particular, FIG. 18 illustrates an exemplary hardware configuration of a workstation 1800 having a central processing unit 1802, such as a microprocessor, and a number of other units interconnected via a system bus 1804.

The workstation shown in FIG. 18 includes a Random Access Memory (RAM) 1806, Read Only Memory (ROM) 1808, an I/O adapter 1810 for connecting peripheral devices such as, for example, disk storage units 1812 and printers 1814 to the bus 1804, a user interface adapter 1816 for connecting various user interface devices such as, for example, a keyboard 1818, a mouse 1820, a speaker 1822, a microphone 1824, and/or other user interface devices such as a touch screen or a digital camera to the bus 1804, a communication adapter 1826 for connecting the workstation 1800 to a communication network 1828 (e.g., a data processing network) and a display adapter 1830 for connecting the bus 1804 to a display device 1832. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Bemers-Lee, D. Connoly, “RFC 1866: Hypertext Markup Language-2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII.). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption /decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

ActiveX is the name Microsoft has given to a set of strategic object-orientated programming technologies and tools. The main technology is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requester. Both Microsoft and Netscape browsers support JavaScript.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for initiating a software download, comprising:
a) accessing via a network a page of a web site utilizing a browser application running on a client computer, wherein a plug-in application is included the page of the web site;
b) determining whether the client computer is suitable for receiving the plug-in application;
c) downloading the plug-in application from the web site to the client computer via the network if the client computer is determined to be suitable for receiving the plug-in application, wherein the plug-in application has instructions for downloading a download manager application to the client computer via the network;
d) downloading the download manager application to the client computer via the network utilizing the plug-in application, wherein the download manager application has instructions for downloading a software application in chunks to the client computer via the network; and
e) downloading the software application in chunks to the client computer via the network utilizing the download manager application.

2. The method of claim 1, wherein the plug-in application comprises at least one of an ActiveX control and a JavaScript application.

3. The method of claim 1, wherein a security feature of the browser application of the client computer requires that a user authorize the downloading of the plug-in application.

4. The method of claim 3, wherein the security feature includes displaying a message to the user that notifies the user to authorize the downloading of the plug-in application.

5. The method of claim 3, wherein another page of the web site is displayed to the user if the authorization to download the plug-in application is denied by the user.

6. The method of claim 3, wherein information about whether or not the downloading of the plug-in application was authorized by the user is stored in the client computer.

7. The method of claim 1, wherein determining the suitability of the client computer for receiving the plug-in application includes determining whether the number of times the client computer has accessed the web site is under a predetermined threshold number.

8. The method of claim 1, wherein another page of the web site is displayed on the if the client computer is determined to be unsuitable for receiving the plug-in application.

9. The method of claim 1, wherein a license agreement is displayed on the client computer to the user prior to the downloading of the plug-in application.

10. The method of claim 1, wherein the determination of the suitability of the client computer for receiving the plug-in application is carried out by another web site.

11. The method of claim 1, wherein the page of the web site launches a window which initiates the determination of the suitability of the client computer for receiving the plug-in application.

12. A system for initiating a software download, comprising:
a) logic for accessing via a network a page of a web site utilizing a browser application running on a client computer, wherein a plug-in application is included the page of the web site;
b) logic for determining whether the client computer is suitable for receiving the plug-in application;
c) logic for downloading the plug-in application from the web site to the client computer via the network if the client computer is determined to be suitable for receiving the plug-in application, wherein the plug-in application has instructions for downloading a download manager application to the client computer via the network;
d) logic for downloading the download manager application to the client computer via the network utilizing the plug-in application, wherein the download manager application has instructions for downloading a software application in chunks to the client computer via the network; and
e) logic for downloading the software application in chunks to the client computer via the network utilizing the download manager application.

13. The system of claim 12, wherein the plug-in application comprises at least one of an ActiveX control and a JavaScript application.

14. The system of claim 12, wherein a security feature of the browser application of the client computer requires that a user authorize the downloading of the plug-in application.

15. The system of claim 14, wherein the security feature includes displaying a message to the user that notifies the user to authorize the downloading of the plug-in application.

16. The system of claim 14, wherein another page of the web site is displayed to the user if the authorization to download the plug-in application is denied by the user.

17. The system of claim 14, wherein information about whether or not the downloading of the plug-in application was authorized by the user is stored in the client computer.

18. The system of claim 12, wherein determining the suitability of the client computer for receiving the plug-in application includes determining whether the number of times the client computer has accessed the web site is under a predetermined threshold number.

19. The system of claim 12, wherein another page of the web site is displayed on the if the client computer is determined to be unsuitable for receiving the plug-in application.

20. The system of claim 12, wherein a license agreement is displayed on the client computer to the user prior to the downloading of the plug-in application.

21. The system of claim 12, wherein the determination of the suitability of the client computer for receiving the plug-in application is carried out by another web site.

22. The system of claim 12, wherein the page of the web site launches a window which initiates the determination of the suitability of the client computer for receiving the plug-in application.

23. A computer program product for initiating a software download, comprising:
a) computer code for accessing via a network a page of a web site utilizing a browser application running on a client computer, wherein a plug-in application is included the page of the web site;
b) computer code for determining whether the client computer is suitable for receiving the plug-in application;
c) computer code for downloading the plug-in application from the web site to the client computer via the network if the client computer is determined to be suitable for receiving the plug-in application, wherein the plug-in application has instructions for downloading a download manager application to the client computer via the network;
d) computer code for downloading the download manager application to the client computer via the network utilizing the plug-in application, wherein the download manager application has instructions for downloading a software application in chunks to the client computer via the network; and
e) computer code for downloading the software application in chunks to the client computer via the network utilizing the download manager application.

24. The computer program product of claim 23, wherein the plug-in application comprises at least one of an ActiveX control and a JavaScript application.

25. The computer program product of claim 23, wherein a security feature of the browser application of the client computer requires that a user authorize the downloading of the plug-in application.

26. The computer program product of claim 25, wherein the security feature includes displaying a message to the user that notifies the user to authorize the downloading of the plug-in application.

27. The computer program product of claim 25, wherein another page of the web site is displayed to the user if the authorization to download the plug-in application is denied by the user.

28. The computer program product of claim 25, wherein information about whether or not the downloading of the plug-in application was authorized by the user is stored in the client computer.

29. The computer program product of claim 23, wherein determining the suitability of the client computer for receiving the plug-in application includes determining whether the number of times the client computer has accessed the web site is under a predetermined threshold number.

30. The computer program product of claim 23, wherein another page of the web site is displayed on the if the client computer is determined to be unsuitable for receiving the plug-in application.

31. The computer program product of claim 23, wherein a license agreement is displayed on the client computer to the user prior to the downloading of the plug-in application.

32. The computer program product of claim 23, wherein the determination of the suitability of the client computer for receiving the plug-in application is carried out by another web site.

33. The computer program product of claim 23, wherein the page of the web site launches a window which initiates the determination of the suitability of the client computer for receiving the plug-in application.

34. A method for initiating a software download, comprising:
a) accessing via a network a first page of a web site utilizing a browser application running on a client computer, wherein a plug-in application is included the first page of the web site, wherein the plug-in application comprises at least one of an ActiveX control;
b) determining whether the client computer is suitable for receiving the plug-in application, wherein determining the suitability of the client computer for receiving the plug-in application includes determining whether the number of times the client computer has accessed the web site is under a predetermined threshold number, wherein a second page of the web site is displayed on the if the client computer is determined to be unsuitable for receiving the plug-in application;
c) downloading the plug-in application from the web site to the client computer via the network if the client computer is determined to be suitable for receiving the plug-in application, wherein a security feature of the browser application of the client computer requires that a user of the client computer authorize the downloading of the plug-in application, wherein the plug-in application has instructions for downloading a download manager application to the client computer from a second web site via the network;
d) downloading the download manager application to the client computer via the network utilizing the plug-in application, wherein the download manager application has instructions for downloading a software application in chunks to the client computer via the network from a web site other than the web site having the plug-in application; and
e) downloading the software application in chunks to the client computer via the network utilizing the download manager application.
